(19) United States
(12) Patent Application Publication
(10) Pub. No.: US 2009/0080820 A1
(43) Pub. Date: Mar. 26, 2009

(54) HYDRODYNAMIC AXIAL PLAIN BEARING AND ASSOCIATED OPERATING METHOD

(75) Inventors: Kamil Matyscak, Uehlingen-Birkendorf (DE); Axel Guenter Albert Fuerst, Uster (CH); Andreas Schubert, Bad Saeckingen (DE)

Correspondence Address: DARBY & DARBY P.C., P.O. BOX 770, Church Street Station, New York, NY, 10008-0770, US

(73) Assignee: ALSTOM Technology Ltd, Baden (CH)

(21) Appl. No.: 12/240,079

(22) Filed: Sep. 29, 2008

Related U.S. Application Data
(63) Continuation of application No. PCT/EP2007/052658, filed on Mar. 20, 2007.

(30) Foreign Application Priority Data
Mar. 31, 2006 (DE) 10 2006 015531.9

(51) Int. Cl. F16C 17/04

(52) U.S. Cl. 384/293

(57) ABSTRACT

A bearing segment of a heavy-duty hydrodynamic axial plain bearing for an electric machine and including a stationary subassembly and a rotary subassembly is described. The bearing segment includes a sliding surface facing a front surface of the rotary subassembly and in close proximity to the front surface so as to form a lubricant gap containing a lubricant between the sliding surface and the front surface. The front surface slides relative to the sliding surface when the rotary subassembly is rotating so as to create a high pressure region and a low pressure region of the lubricant gap. The bearing segment also includes an equalizing duct interconnecting the high-pressure region and the low-pressure region.

### CROSS REFERENCE TO PRIOR APPLICATIONS

This application is a continuation International Patent Application No. PCT/EP2007/052658, filed on Mar. 20, 2007 and published in the German language on Oct. 11, 2007 as WO 2007/113103, which claims priority to German Patent Application No. DE 10 2006 015 531.9, filed on Mar. 31, 2006. The entire disclosure of both applications is incorporated by reference herein.

The invention relates to a hydrodynamic axial plain bearing, which is designed, in particular, for high stresses. Such an axial plain bearing can be used, in particular, to support shafts of large electric machines, such as hydro generators. The invention also relates to a method for operating a hydrodynamic axial plain bearing of this type.

### BACKGROUND

For the axial support of shafts of large electric machines, such as hydro generators, heavy-duty hydrodynamic axial plain bearings are used to absorb the axial forces, particularly when the respective shaft is arranged upright, i.e. with vertical rotation axis. The bearing segments, which perform a relative movement to one another, have mutually facing plane sliding surfaces, between which a load-bearing hydrodynamic lubricating film builds up during operation. The thickness of the lubricating film is here dependent on a number of factors, in particular on the load upon the axial plain bearing. Within the axial plain bearing, the considerable shearing stress upon the lubricant interspersed between the stationary rotary components gives rise to a significant warming of the same, which generally necessitates an internal or external cooling of the lubricant in order to prevent an excessive warming resulting in thermal damaging of the same, and also to ensure with some reliability the operativeness of the axial plain bearing.

In the case of large-area bearing segments, considerable temperature differences within the bearing segments can here arise between the regions directly adjacent to the sliding surface and the regions further distant therefrom, which temperature differences are manifested in thermal stresses, which together impair the load-bearing capacity and working life of these components.

### SUMMARY OF THE INVENTION

An aspect of the present invention is to provide a hydrodynamic axial plain bearing and for an associated operating method an improved embodiment, which, particularly by comparison with traditional plain bearings of the same size, allows an increased load while the running reliability remains at least the same.

According to the present invention, within the lubricant gap, in a relatively high-pressure region of the lubricant, a part-stream of the lubricant is extracted and returned into a relatively low-pressure region of the lubricant back into the lubricant gap.

During the operation of the axial plain bearing, a considerable pressure gradient is formed within the lubricant gap. A typical pressure curve within the lubricant gap of a traditional axial plain bearing is represented by way of example in FIG. 6. In the region of the highest or approximately highest pressure within the lubricant gap, there is arranged, according to the invention, at least one inlet opening into an equalizing duct, which, at a distance from the sliding surface, penetrates the bearing segment or runs within the bearing segment and, at a place of relatively low pressure, re-enters the lubricant gap via at least one outlet opening. Owing to the existing pressure difference, a recirculation of a part of the lubricant is initiated, in that a part-stream of the same in the region of the high pressure passes from the lubricant gap into the equalizing duct, flows through the latter counter to the principal direction of flow of the lubricant in the lubricant gap, so as finally, in a region of the bearing segment, to re-enter the lubricant gap at lower pressure and combine with the lubricant which is already present there.

Since the lubricant is removed in a downstream high pressure region and is fed to an upstream low pressure region, the pressure level in the removal region is reduced and in the feed-in region is raised. In consequence, a more balanced pressure distribution within the lubricant gap of the respective bearing segment of the axial plain bearing is realized. The system may be self-regulating. In dependence on the prevailing pressure conditions, the flow cross sections and the viscosity of the lubricant, a state of equilibrium is automatically achieved during operation. Additional control measures may be therefore unnecessary.

Surprisingly, it has also been found that the measure according to the invention produces an enlargement of the lubricant gap relative to a comparable axial plain bearing without the measure according to the invention. From this follow the additional advantages of increased running reliability due to the thicker lubricating film, and the prospect, arising therefrom, of a greater loading of the axial plain bearing.

In addition, an enlargement of the lubricant gap produces an enhanced throughput of lubricant through the lubricant gap. This increases the supply of fresh, cold lubricant, whereby, on the one hand, the temperature of, and thus the thermal load upon the lubricant itself falls and, on the other hand, the temperature of the sliding surfaces therefore also falls. This, in turn, results in a reduced thermal load upon the respective bearing segment and, hand in hand with this, in the case of large-area bearing segments, in a reduced risk of deformation resulting from large differences in body temperature. In addition, the warm lubricant flowing, in the at least one equalizing duct, through the respective bearing segment helps to produce a balanced body temperature within the respective bearing segment.

Further important features and advantages of the invention emerge from the claims, from the drawings and from the associated figure description with reference to the drawings.

### BRIEF DESCRIPTION OF THE DRAWINGS

Preferred illustrative embodiments of the invention are represented in the drawings and are explained in greater detail in the following description, the same or similar or functionally identical or mutually corresponding elements figuring under the same reference symbols. In the drawings, respectively in schematic representation,

FIG. 1 shows an axial top view of a bearing segment of an axial plain bearing,

FIG. 2 shows a sectional view of the bearing segment along the sectional lines D-D in FIG. 1,

FIG. 3 shows a view of the bearing segment in the peripheral direction in accordance with a direction of view III in FIG. 2,

FIG. 5 shows a sectional view of the bearing segment in accordance with the sectional lines C-C in FIG. 3,

FIG. 6 shows a chart for illustrating the pressure conditions within a lubricant gap in respect of a traditional bearing segment,

FIG. 7 shows a chart for illustrating the pressure conditions within a lubricant gap in the case of the bearing segment according to the invention.

### DETAILED DESCRIPTION

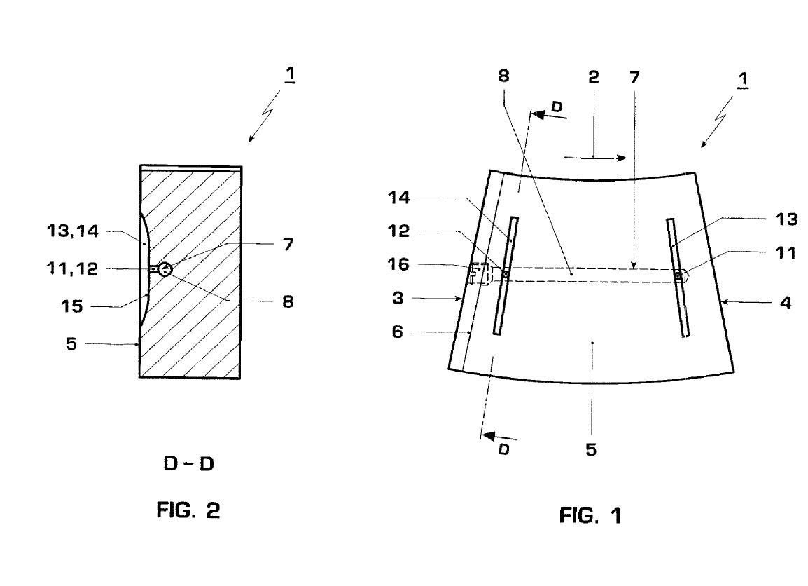

FIGS. 1 to 5 show a supporting segment or bearing segment 1 of a heavy-duty, hydrodynamic axial plain bearing (otherwise not shown), as can be used, for example, on a vertical electric machine, such as a hydro generator. Expediently, a plurality of these bearing segments 1 are here arranged in the shape of a ring with respect to a rotation axis of a rotor of this machine. Said rotor is axially supported on these bearing segments 1 of the axial plain bearing. The bearing segments 1 of the axial plain bearing themselves rest, in turn, upon a fixed base, i.e. are stationary. The axial plain bearing is immersed in lubricating oil. During the operation of the machine, between communicating contact surfaces or sliding surfaces of the rotor, on the one hand, and of the bearing segments 1, on the other hand, a friction-reducing lubricating film is formed, which is fed from a lubricant bath and/or via ducts of a high-pressure lubrication in a manner which is known per se. For example, the rotor rotates in a rotational direction 2 marked in FIG. 1 by an arrow. For the stationary bearing segment 1 for the lubricant conveyed by the rotation of the rotor, a leading edge 3 and a trailing edge 4 are thereby obtained. On the inflow side, the respective bearing segment 1 is beveled on its sliding surface 5 which in FIG. 1 faces the observer. A corresponding bevel line is denoted in FIG. 1 by 6. The bevel 6 serves to facilitate the penetration of the lubricating oil into the lubricant gap which is formed axially between the sliding surface 5 of the respective bearing segment 1 and the corresponding sliding surface of the rotor.

The respective axial plain bearing thus comprises two mutually adjustable subassemblies, namely a rotary subassembly and a stationary subassembly. The rotary subassembly is configured with its sliding surfaces on the rotor, while the stationary subassembly comprises the bearing segments 1 with their sliding surfaces 5.

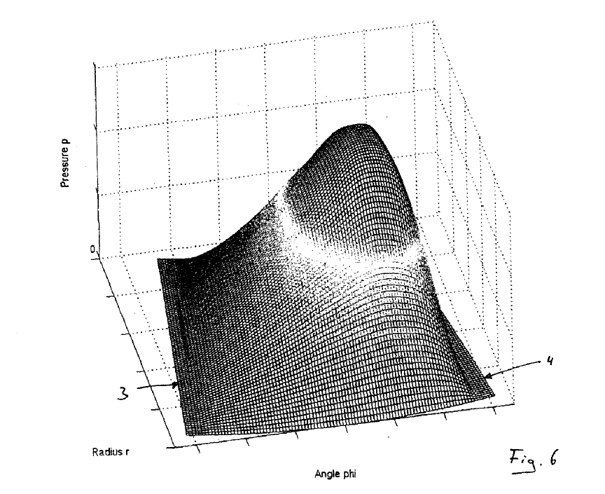

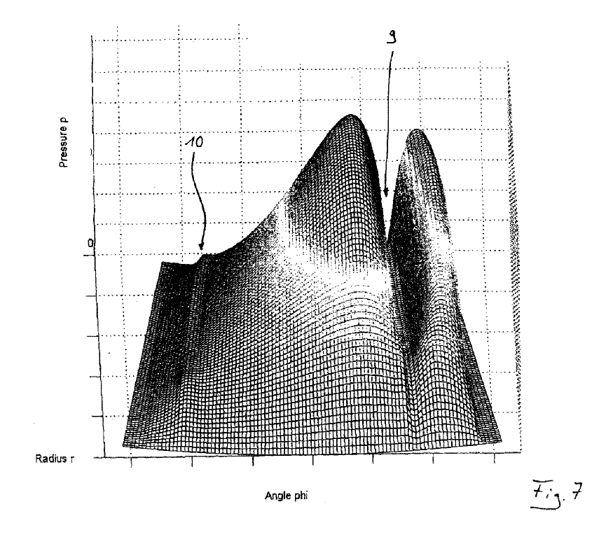

In a traditional axial plain bearing equipped with traditional bearing segments 1, that pressure distribution on the sliding surface 5 of the respective bearing segment 1 which is represented in FIG. 6 is established during operation. The pressure from the leading edge 3 up to the trailing edge 4 discernibly first increases and then decreases again. The pressure curve reaches its maximum roughly in the middle of the trailing-side third of the respective bearing segment 1.

In the inventive operation of the axial plain bearing, within the lubricant gap a part-quantity of the lubricant is now drawn off from a region of relatively high hydrostatic pressure and returned into a region of relatively low hydrostatic pressure within the lubricant gap. Preferably, the removal of the lubricant and the introduction of the lubricant respectively takes place within such a bearing segment 1, in particular in respect of each of these bearing segments 1 of the axial plain bearing. To this end, within the respective bearing segment 1, a lubricant path 7 can preferably be configured, which runs inside the respective bearing segment 1 and via which the lubricant is removed from the high-pressure region and introduced into the low-pressure region.

For the realization of this transport of lubricant from the high-pressure region to the low-pressure region within the respective bearing segment 1, the respective bearing segment 1 contains at least one equalizing duct 8. The respective equalizing duct 8 extends inside the respective bearing segment 1 at a distance from the sliding surface 5. The respective equalizing duct 8 serves to connect the high-pressure region in the lubricant gap to the low-pressure region in the lubricant gap, so that, during operation, lubricant can flow from the high-pressure region to the low-pressure region, to be precise counter to the general direction of flow of the lubricant in the lubricant gap, corresponding to the rotational direction 2.

FIG. 7 now shows the pressure curve in the lubricant gap along the sliding surface 5 in the bearing segment 1 according to the invention and in an axial plain bearing according to the invention. At 9, the removal of the lubricant from the lubricant gap takes place, whereby the high-pressure region exhibits a significant intrusion and now, instead of one maximum, has two maxima. At 10, the introduction of lubricant into the lubricant gap takes place, whereby, in this low-pressure region, the mean pressure is significantly raised; at the same time, a (lesser) pressure maximum can also be formed there. Overall, a certain pressure equalization is thus obtained within the sliding surface 5 of the respective bearing segment 1. The pressure level in the low-pressure region, i.e. in an inflow-side or front region of the respective bearing segment 1, is thereby raised, while, at the same time, the pressure level in the high-pressure region, i.e. in an outflow-side or rear region of the bearing segment 1, is correspondingly lowered. In consequence, within the lubricant gap, a more favorable pressure distribution is obtained, which increases the load-bearing capacity and working life of the axial plain bearing.

In bearing segments 1 which are mounted pivotably about a bearing shaft that is radially orientated with respect to the rotation axis, the pressure shift gives rise counter to the inflow to a tilting moment, which enlarges the lubricant gap on the inflow side of the respective bearing segment 1 and hence improves the lubricant feed into the lubricant gap. Surprisingly, an enlargement of the lubricant gap can also be observed, which likewise leads to a reduction of the load upon and an extension of the life of the axial plain bearing.

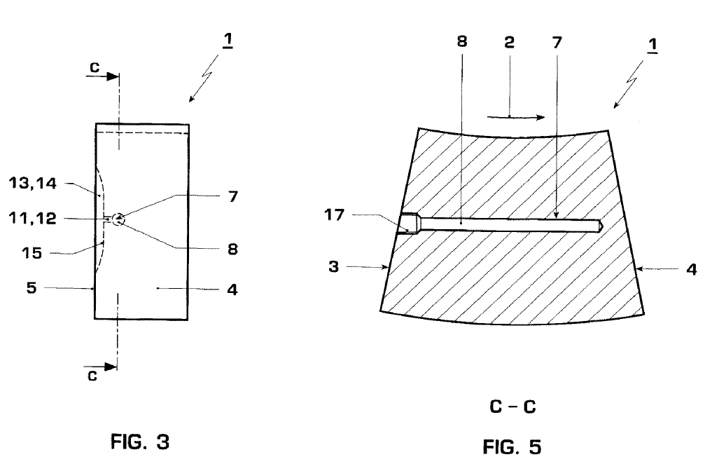

In accordance with FIG. 1 to 3, the respective bearing segment 1 has at least one inlet opening 11, which is disposed in the high-pressure region of the lubricant gap and through which the lubricant makes its way out of the lubricant gap into the equalizing duct 8. The bearing segment 1 further has at least one outlet opening 12, which is disposed in the low-pressure region of the lubricant gap and through which the lubricant is returned from the equalizing duct 8 into the lubricant gap. The equalizing duct 8 thus connects the inlet opening 11 communicating with the lubricant gap to the outlet opening 12 likewise communicating with the lubricant gap. In the preferred embodiment which is shown here, the inlet opening 11 is disposed on the floor of an inlet groove 13 which is configured in the sliding surface 5, for example is milled into the bearing segment 1. Correspondingly, for the outlet opening 12 also, an outlet groove 14 can be provided, which is configured in the sliding surface 5, for example is recessed in the bearing segment 1 by milling. At least one of these grooves 13, 14, in the example both grooves 13, 14, is rectilinear in shape and is here orientated radially to the rotation axis of the rotor or of the rotary subassembly. Moreover, the respective groove 13, 14 extends over a comparatively large region of the radial width of the respective bearing segment 1. The pressure equalization hence takes place within comparatively large regions defined by the grooves 13, 14. Furthermore, at least one of the grooves 13, 14, preferably both grooves 13, 14, can respectively have a profile 15 which in longitudinal section is concavely arched in the direction of the sliding surface 5, as can clearly be seen, for example, from FIGS. 2 and 3. The respective opening, i.e. the inlet opening 11 and/or the outlet opening 12, is preferably disposed roughly midway between the longitudinal ends of the respective groove 13 or 14.

The respective inlet opening 11 is positioned in the high-pressure region of the lubricant gap within the sliding surface 5 of the respective bearing element 1. Preferably, the respective inlet opening 11 is thus disposed in an outflow-side third of the sliding surface 5. Preferably, the inlet opening 11 is disposed roughly centrally in the outflow-side third of the sliding surface 5. In contrast, the respective outlet opening 12 is disposed in the low-pressure region of the lubricant gap within the sliding surface 5 of the respective bearing segment 1. Expediently, the respective outlet opening 12 is thus positioned within an inflow-side third of the sliding surface 5. Preferably, the outlet opening 12 is disposed roughly centrally in the inflow-side third of the sliding surface 5.

The equalizing duct 8 can be closed, for example, according to FIG. 1, by means of a closing element 16, which can be configured, for example, as a grub screw. To this end, the closing element 16 is screwed into a corresponding receiving opening 17, which is discernible in FIG. 5. For the insertion of the closing element 16, a suitable screwing tool can be used.

When the machine is inactive, in respect of the individual bearing segments 1, the sliding surface of the rotary component, i.e. the rotor, rests directly on the sliding surface 5 of the respective bearing segment 1; in the event of this direct contacting, the lubricant gap is not present. In order to be able to start up the machine, the lubricant gap must be created. For this purpose, it is known, at suitable high-pressure lubrication points and with the aid of a pumping device, to force lubricant under high pressure into the contact zone between the axially adjoining sliding surfaces. The lubricant gap is thereby generated, which allows the machine to be started. As soon as the rotary component starts turning, it conveys lubricant via the bevel 6 into the lubricant gap. According to the pumping effect of this relative movement, the operation of the pumping device can be adjusted, since sufficient lubricant reaches the lubricant gap through transportation by the rotor. According to one particularly advantageous embodiment, the pumping device, at least in respect of one of the bearing segments 1, can now be connected to at least one of the equalizing ducts 8. When the machine is to be started, the pumping device can thus convey lubricant under high pressure via the equalizing duct 8, and thus, in particular, via the inlet opening 11 and the outlet opening 12, as well as, if need be, via the inlet groove 13 and the outlet groove 14, into the lubricant gap. This means that, when the machine is to be started, the lubricant path 7 configured for the pressure equalization in the respective bearing segment 1 is used to force lubricant into the lubricant gap. As soon as the pumping effect of the rotary subassembly is sufficient to convey sufficient lubricant into the lubricant gap, the pumping device can be switched off, so that, via the respective equalizing duct 8 or the lubricant path 7, the desired pressure equalization of the lubricant gap is again realized. In this context, it is clear that the respective pumping device is connected to the lubricant path 7 or to the respective equalizing duct 8 by at least one suitable, corresponding return-blocking device.

### REFERENCE SYMBOL LIST

1 bearing segment
2 rotational direction
3 leading edge
4 trailing edge
5 sliding surface
6 bevel
7 lubricant path
8 equalizing duct
9 removal point
10 feed-in point
11 inlet opening
12 outlet opening
13 inlet groove
14 outlet groove
15 profile
16 closing element
17 receiving fixture

What is claimed is:

1. A bearing segment of a heavy-duty hydrodynamic axial plain bearing for an electric machine, the bearing including a stationary subassembly and a rotary subassembly, the bearing segment comprising:
a sliding surface facing a front surface of the rotary subassembly and in close proximity to the front surface so as to form a lubricant gap containing a lubricant between the sliding surface and the front surface, wherein the front surface slides relative to the sliding surface when the rotary subassembly is rotating so as to create a high pressure region and a low pressure region of the lubricant gap; and
an equalizing duct interconnecting the high-pressure region and the low-pressure region.

2. The bearing segment as recited in claim 1, wherein the electric machine is a hydro generator.

3. The bearing segment as recited in claim 1, wherein equalizing duct runs beneath the sliding surface and connects at least one inlet opening communicating with the lubricant gap to at least one outlet opening communicating with the lubricant gap.

4. The bearing segment as recited in claim 3, further comprising an inlet groove in the sliding surface, wherein the at least one inlet opening is disposed in the inlet groove.

5. The bearing segment as recited in claim 3, further comprising an outlet groove in the sliding surface and wherein the at least one outlet opening is disposed in the outlet groove.

6. The bearing segment as recited in claim 4, wherein the inlet groove is rectilinear in shape and is orientated radially to a rotation axis of the rotary subassembly.

7. The bearing segment as recited in claim 4, wherein the inlet groove is elongated and a longitudinal section of the inlet groove has a profile concavely arched.

8. The bearing segment as recited in claim 4, wherein the inlet groove is elongated and the inlet opening is disposed midway between longitudinal ends of the inlet groove.

9. The bearing segment as recited in claim 5, wherein the outlet groove is rectilinear in shape and is orientated radially to a rotation axis of the rotary subassembly.

10. The bearing segment as recited in claim 5, wherein the outlet groove is elongated and a longitudinal section of the outlet groove has a profile concavely arched.

11. The bearing segment as recited in claim 5, wherein the outlet groove is elongated and the outlet opening is disposed midway between longitudinal ends of the outlet groove.

12. The bearing segment as recited claim 3, wherein the inlet opening is disposed in an outflow-side third of the sliding surface.

13. The bearing segment as recited claim 3, wherein the outlet opening is disposed in an inflow-side third of the sliding surface.

14. An axial plain bearing for an electric machine, comprising a plurality of bearing segments as recited in claim 1.

15. The axial plain bearing as recited in claim 14, further comprising a pumping device configured to feed the lubricant into the lubricant gap for starting the electrical machine.

16. A method of operating an axial plain bearing for an electric machine having a rotary subassembly and a stationary subassembly, a lubricant gap having a lubricant being disposed between the stationary subassembly and the rotary subassembly, the method comprising:
rotating the rotary subassembly relative to the stationary subassembly so as to provide a high-pressure region and a low-pressure region of the lubricant gap; and
removing a portion of the lubricant from the high-pressure region and introducing the portion of the lubricant to the low-pressure region.

17. The method as recited in claim 16, wherein the removing and the introducing of the portion of the lubricant is performed within at least one bearing segment of the stationary subassembly of the axial plain bearing.

18. The method as recited in claim 17, wherein the removing and the introducing of the portion of the lubricant is performed using a lubricant path running inside the bearing segment.

19. The method as recited in claim 18, further comprising pumping the lubricant via the lubricant path into the lubricant gap for starting of the electric machine.
